(19) United States
(12) Patent Application Publication
(10) Pub. No.: US 2011/0246941 A1
(43) Pub. Date: Oct. 6, 2011

(54) Visual Interface Direct Alphanumeric Navigation Through Displayed Items

(76) Inventor: George E. Gonzalez, McLean, VA (US)

(21) Appl. No.: 12/940,296

(22) Filed: Nov. 5, 2010

Related U.S. Application Data
(60) Provisional application No. 61/258,269, filed on Nov. 5, 2009.

(51) Int. Cl. G06F 3/048

(52) U.S. Cl. 715/816; 715/840

(57) ABSTRACT

Direct alphanumeric navigation techniques are provided to allow for a user to directly navigate to a particular item in a list of items arranged in a predetermined order, based on key presses of a basic numeric keypad, where each key in key pad has one or more letters assigned to it. These techniques facilitate selection of an item within a long list of items without the use of incremental navigation or search functions.

### CROSS REFERENCE TO RELATED APPLICATION

This application claims priority to U.S. Provisional Patent Application No. 61/258,269, filed Nov. 5, 2009, the entirety of which is incorporated herein by reference.

### TECHNICAL FIELD

The present disclosure relates to a graphical user interface technique for directly navigating to an item among a plurality of items presented for display on a display device.

### BACKGROUND

Typical remote control devices and other user interface input devices permit users to navigate lists or menus through the use of direction keys such as up, down, left, and right buttons. In addition, some remote control devices use page up and page down keys to assist a user in scrolling through displayed information. However, when traversing many items (i.e., 20 or more) on a screen or long lists, i.e. hundreds or thousands of items, navigation is tedious and requires the user to press many keys to get to the desired item or location.

In general, remote control devices have a limited number of keys. A technique that can simplify a user's ability to navigate a list of items using a remote control device is highly desirable.

### SUMMARY

Techniques are provided herein for direct alpha navigation (DAN) using a remote control device. These techniques leverage a user's prior knowledge of cell phone alphanumeric keypad for “texting” functions and the keypad on a remote control device to permit the user to directly navigate either on a currently displayed screen or within an extended list of items (some of which are not on the currently displayed screen) by “tapping” an alphanumeric string of one or more characters that begin (or are contained in) a title or name associated with an item in the list. Letters are entered by pressing the corresponding numeric key with one press per letter identified on the key. A sequence of letters can be entered by pressing additional keys.

Based on the string of letter(s) entered on the remote control keypad, a direct navigation is made to an item in the list that has a name or title that begins or contains, either partially or fully, the entered string. In some cases, this may involve displaying a different screen to show a different portion of the list items which contains the item whose name or title begins with the entered string.

### BRIEF DESCRIPTION OF THE DRAWINGS

FIG. 1 is a diagram depicting an example of a direct alphanumeric navigation technique.

FIGS. 2 and 3 are diagrams depicting examples of displayed lists of items in which a user may navigate using the direct alphanumeric navigation techniques described herein.

FIG. 4 is an example of a block diagram of a remote control device that sends commands to a controlled device in which the direct alphanumeric navigation techniques are implemented.

FIG. 5 is an example of a block diagram of a configuration in which the alphanumeric keypad resides in the same device in which the direct alphanumeric navigation techniques are implemented.

FIG. 6 is a timing diagram that depicts operation of two timers in connection with a direct alphanumeric navigation process.

FIG. 7 is an example of a flow chart for the direct alphanumeric navigation process.

FIGS. 8-10 are diagrams illustrating example cases for the direct alphanumeric navigation techniques.

FIG. 11 is a flow chart that depicts an overall user interface display process in which the direct alphanumeric navigation techniques may be employed.

### DETAILED DESCRIPTION

Direct alphanumeric navigation techniques are provided to allow a user to directly navigate to a particular item in a list of items arranged in a predetermined order, based on key presses of a basic numeric keypad, where each key in key pad has one or more letters assigned to it.

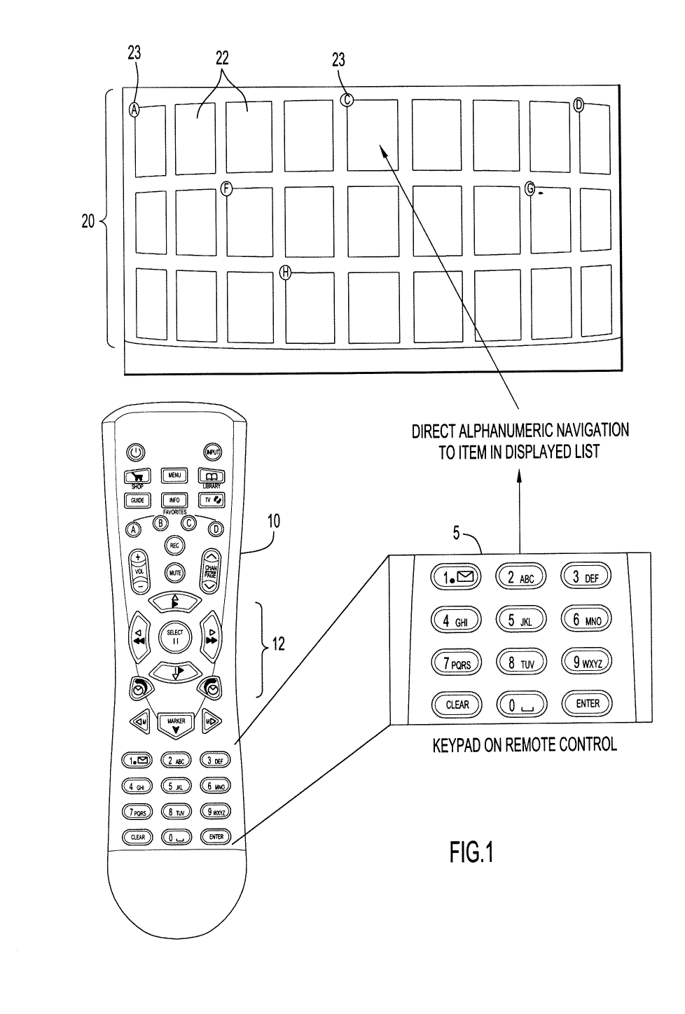

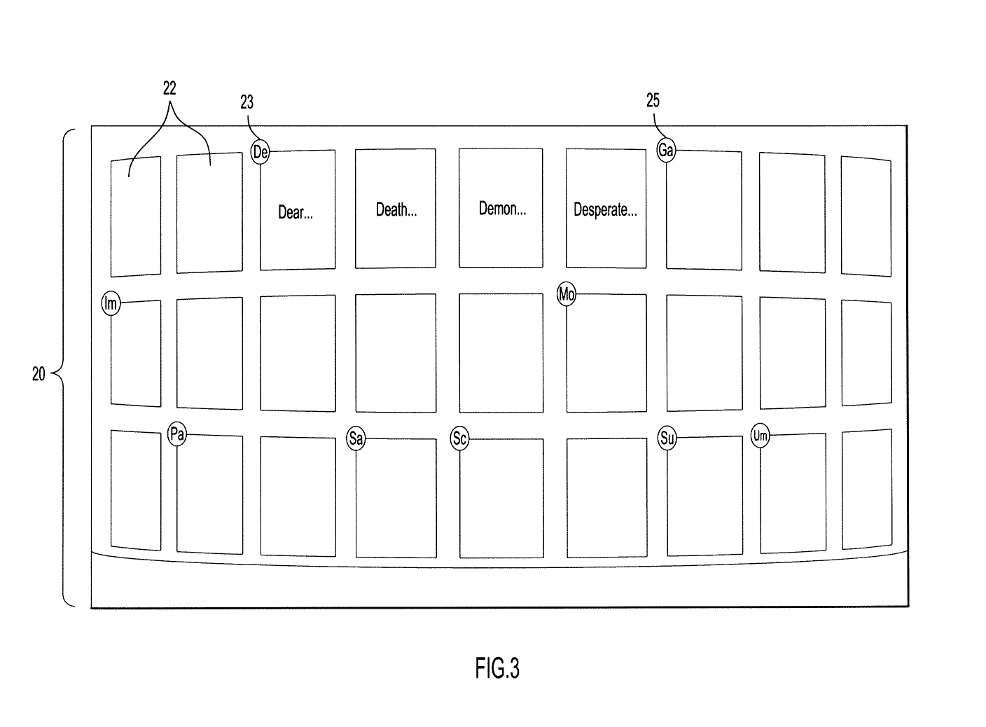

Referring first to FIG. 1, a configuration is shown in which an alphanumeric keypad 5 is used to send commands to directly navigate through a displayed list of items shown at 20. The alphanumeric keypad 5 may be part of the remote control device 10. The displayed list of items 20 comprises a plurality of graphical (or text) elements 22 arranged in a predetermined order, such as alphabetical order. The display list may be displayed as a list of items either graphically or in text format, where each item in the list is on a different vertical line or is laterally displaced from other items in the list. The displayed list of items 20 may be displayed by a device, such as a television, computer display, hand-held device, etc. There is a navigational “orb” or marker 23 that divides groups of items in the list according to alphabetical groups. The use of navigational markers is explained further hereinafter in connection with FIGS. 3 and 3.

The numeric keys or buttons “0”-“9” in the keypad 5 each have associated therewith a corresponding group of letters or characters, as is well known in the art. For example, key “2” has the letters “A”, “B” and “C” associated with it. The “1” key has the “@” and “*” characters associated with it (though only the “@” character is shown in the “1” key) and the “0” key has the “.” (i.e., period) and space characters associated with it. These numeric keys are used to directly navigate to a desired item (or a starting point for a group of items) that has a title or name associated with it which matches, i.e., starts with (or contains) a letter or character associated with that key. This is analogous to a regular expression function in computer science technologies. For example, when the numeric key “2” is pressed three times (subject to certain time constraints described hereinafter), a direct navigation is made to the first item in the list 20 that has a title or name that begins with the letter “C”. Thus, a string of one or more characters or letters obtained from numeric key presses are used to directly navigate to an item in a list of items. A user may enter a string that comprises the entire set of characters or letters that make up the name or title of an item. Alternatively, the user may enter a string that contains the special regular expression characters “*” and “.” to enable wildcard matches of the string. The user may then utilize the “BACK” (left pointing arrow) and “FWD” (right pointing arrow) keys that are part of a set of directional navigation keys shown at reference numeral 12, in order to traverse to other items which contain that string. The numeric keys or buttons may be mechanically actuated buttons or touch-screen areas where the buttons are displayed and may be selected by a touch rather than a press.

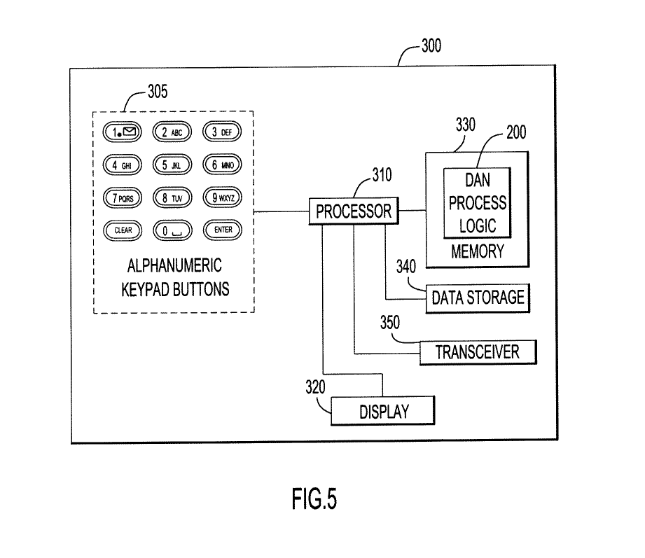

Thus, FIG. 1 generally depicts the direct alphanumeric navigation (DAN) techniques. As will become apparent hereinafter, the DAN techniques are not limited to use with a remote control device. There are many other applications where the alphanumeric keypad and the display screen are part of the same device, an example of which is shown in FIG. 5.

The graphical elements 22 shown in FIG. 1 may be associated with digital media content, such as movies, video programs, video games, audio (songs or programs), or computer application software, etc., and may contain a text for a name or title and associated artwork. When the user initiates an alphanumeric navigation sequence, the DAN technique advances the display list to show the first such matching item as the currently “highlighted” item. For example, the DAN technique moves the position of a cursor or other user interface focus element to a specific item in the list. The position of the cursor, e.g., the “highlighted” item, is identified to the user by some means such as placing a highlighted perimeter (“halo”) around the item to indicate that the user may take further action with regard to the item. Other means to indicate the current position of the cursor may be flashing underline element, color highlighting, flashing text of the item, all of which are particularly useful in a list of text items. The user may then select the highlighted item to retrieve digital content for that item (either from local storage, from a received stream, or from remote storage), for presentation to a user. For example, the graphical elements are icons, splash screens, promotional posters, etc., associated with the digital media content. The digital media content may include application software, game software, music, video programs such as movies, etc., or any other multimedia digital content. However, the action that is invoked upon “selecting” an item to which a user navigates using the DAN technique depends on the context of the list being navigated. For example, the list could be a menu of options that leads to further lists of menu options.

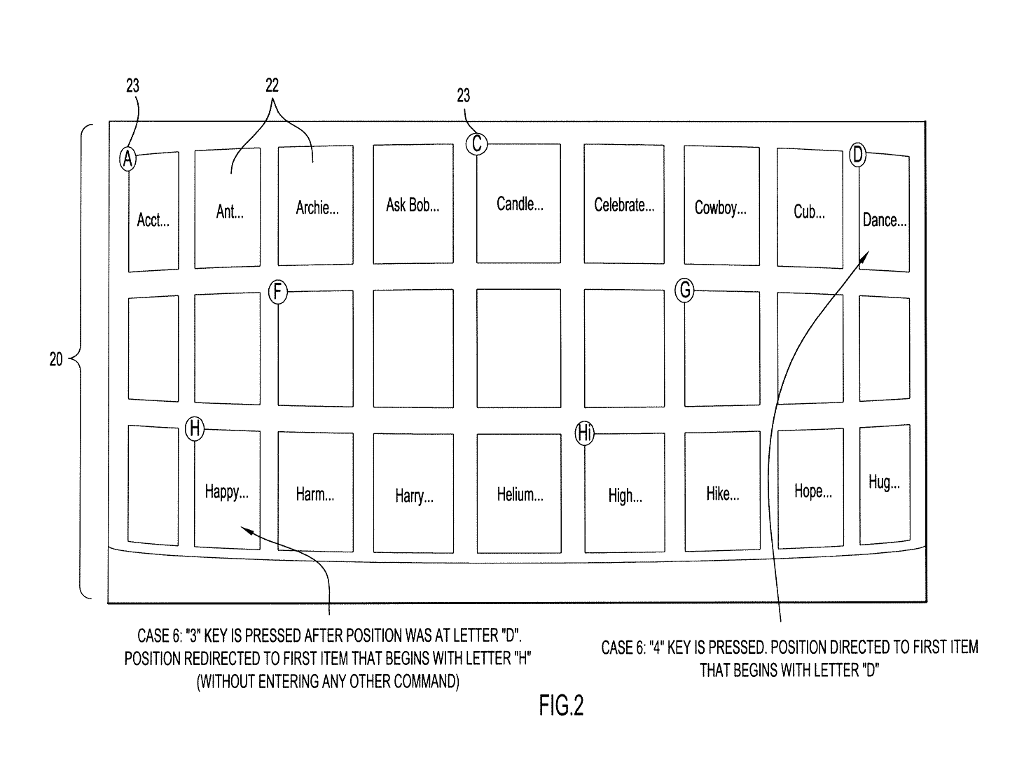

Reference is now made to FIG. 2. FIG. 2 illustrates an example of a displayed list of items 20 in which the graphical elements 22 have words or phrases associated with them (name, title, label, etc.) for the purposes of navigation. The items are arranged in alphabetical order by word or phrase, e.g., by title. Examples of the first few letters or first word of titles for items are shown for the items in the top row in FIG. 2. The items in the other rows would have titles as well, but they are omitted for simplicity.

A navigational orb 23 is displayed for titles that begin within a particular alphabetical letter. When the list does not contain an item for a particular letter in the alphabet, then it is skipped. This is the case in FIG. 2 where there are no items that begin with the letter B to be displayed. All of the graphical elements 22 having a title which begin with the letter A are displayed to the right of the navigational orb 23 for the letter A. Similarly, all of the graphical elements 22 having a title that begin with the letter C are displayed to the right of the navigational orb for the letter C, and so on. In addition, within each group following a navigational orb, the graphical elements are displayed alphabetically.

It should be noted that the placement of orbs are dynamically determined by the system to minimize the number of key presses a user needs to enter in order to highlight and/or select a particular item. The system dynamically analyzes the list items to be displayed and may insert orbs in strategic locations within the displayed list to subdivide the displayed items to optimize navigation. As an example, if a particular list has a large number of entries that begin with a particular letter, for example “H”, the system would insert orbs with more than one letter, i.e., “Hi” on the display so that the number of items between orbs does not exceed a system configurable parameter (in this case 4 items) to facilitate navigation. Notwithstanding the forgoing, the user can navigate to items using the DAN technique even if an item does not have displayed orb. For example in FIG. 2, the user could press keys to input the string “Hu” to directly navigate to the items 24 whose title/name begins with the word “HUG”. FIG. 2 also shows navigation positions associated with example Case 6 described hereinafter.

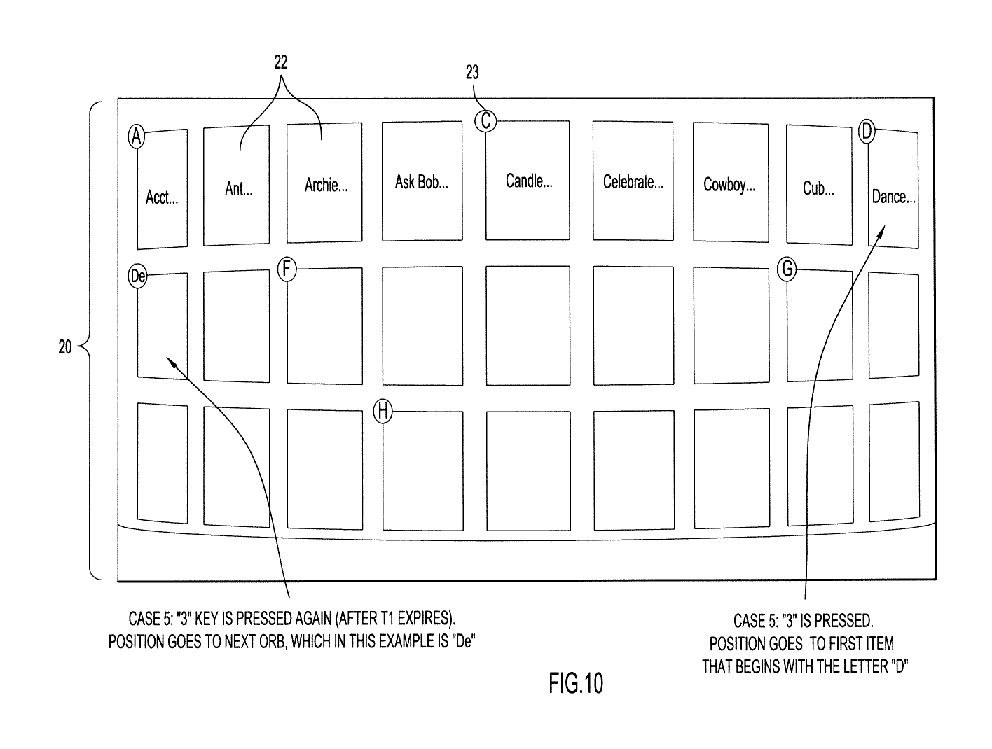

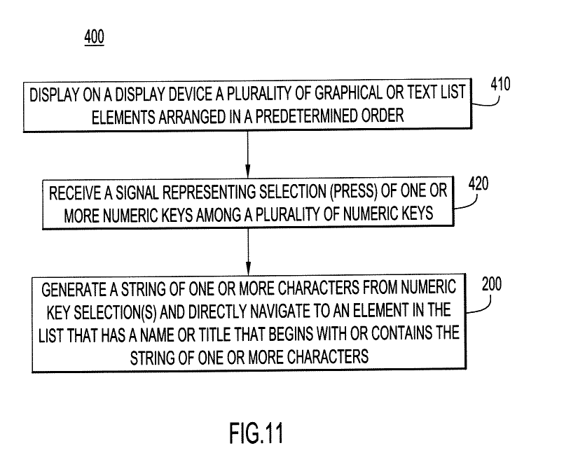

Thus, direct navigation is made to an item in a list based on the string of one or more characters entered. The orbs are displayed to provide a visual break or delineation between items in the list. Moreover, the use of orbs may be user configurable. That is, a user may decide to operate the direction navigation techniques without orbs. In addition, a user may decide to use orbs, and to specify the maximum number of items between orbs for display. There is one example where a user may invoke a navigation function based on orbs, and this example is described hereinafter in connection with FIG. 10. In sum, data representing positions for the orbs (navigational markers) in the list of elements or items is generated dynamically based on predefined or user configurable parameters as to a maximum number of elements or items to be displayed between consecutive navigational markers to optimize visual delineation of groups of the elements.

FIG. 3 shows another example of a displayed list of items 22, where items are arranged alphabetically, but where groups or subsets of items are made by the first two letters of their titles. For example, there is a navigational orb 23 for “De” that denotes graphical elements whose titles begin with the letters “De”, and examples of titles are shown in FIG. 3. Similarly, there is a navigational orb 25 for “Ga”, a navigational orb for “Im”, and so on. Thus, FIG. 3 is meant to be representative of a more refined grouping of items based on the first two letters of their title.

Lists of graphical or text elements (items) may be by category. For example, a given list of items may be for movie titles that fall within a category of “Recent Releases” or “New Releases” or also by topic such as “Drama”, “Science Fiction”, etc. Thus, each list may be specific to a given category and is referred to herein as a list category. Likewise, if the items are associated with music content, there may lists for “New Releases”, as well as “Alternative”, “Blues”, “Jazz”, “Classical”, “Dance”, “Rap”, etc. Generally, the direct alphanumeric navigation techniques described herein allow for a user to directly navigate to an item in a list that is currently being presented to the user (even though all of the items of that list may not be visible on the currently displayed screen). Thus, a user will be directed to an item in the current list category that is being presented based on the string of characters that is entered by the user from selection of one or more numeric keys. This is only an example, and it is possible that a string entered while one list category is being presented can be used to directly navigate to an item in another list category using the string that the user has already entered. In addition, as explained hereinafter in connection with Case 7, a user may jump across list categories using a regular expression function denoted by a leading “*” before an entered string of characters. List categories may be organized in a predetermined order, such as “New Releases”, then “Recent Releases”, then alphabetically by topic such as “Action”, “Comedy”, “Drama”, and so on. Thus, as explained hereinafter, jumping to an item in the “next” list category may involve going to an item in the next list category according to the predetermined order of list categories, depending on which list category is currently being presented to the user.

Again, all of the items in a list that is being presented to a user may not fit within a single displayed screen due to the number of items in the list. Therefore, when a user enters a string for an item that is not on the currently displayed screen but is in the current list category, the display is updated with a another subset set of items of that list, which subset contains the item that has a string of characters that begins with or contains the string of characters entered by the user. The item to which the navigation is made may be displayed in a particular position of the screen (such as center, top left, etc.). Moreover, when a user navigates to a different list category (e.g., Case 7), the display is updated with a different set of items for that list category and to display the item that contains the entered string, which again may involve displaying only a subset of items of that list category on the display screen depending on the number of items in that list category.

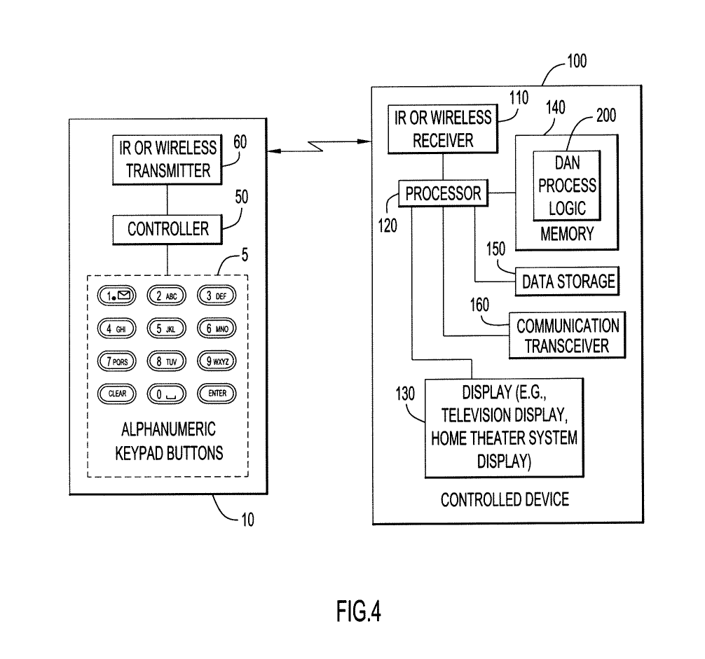

Reference is made to FIG. 4 for an example of a system environment in which the DAN techniques may be employed. The remote control device 10 communicates with a controlled device 100 to supply commands to the controlled device 100. The remote control device 10 comprises the alphanumeric keypad 5, a controller 50 and an infrared (IR) or wireless transmitter 60. There are other components of the remote control device 10 that are not shown in FIG. 4 for the sake of simplicity since they are not relevant to the DAN techniques described herein.

The controlled device 100 comprises an IR or wireless receiver 110, a processor 120, a display 130, memory 140, a data storage unit 150 and optionally a communication transceiver 160. In some configurations, the display 130 may be separate from, but connected to, the controlled device 100. For example, the controlled device 100 may be an intermediate device, e.g., a set-top box or a media server personal computer (“PC”) that connects to a television, in which case the display 130 is a television display that is separate from the controlled device. However, the controlled device 100 may be a television. In other examples, the controlled device 100 may be a video display system, home theater systems, media server, etc. The list of items (FIGS. 2 and 3) is displayed on a screen of the display 130.

The processor 120 is a microprocessor or microcontroller, for example. The memory 140 stores DAN process logic 200 that, when executed by the processor 120, causes the processor to perform the functions described herein and in connection with the accompanying figures.

The functions of the processor 120 may be implemented by logic encoded or stored in one or more tangible processor readable media (e.g., embedded logic such as an application specific integrated circuit, digital signal processor instructions, software that is executed by a processor, etc.), wherein the memory 140 stores data used for the computations described herein and stores software or processor instructions that are executed to carry out the computations described herein. Thus, the process logic 200 may take any of a variety of forms, so as to be encoded in one or more tangible media for execution, such as with fixed logic or programmable logic (e.g., software/computer instructions executed by a processor) and the controller 38 may be a programmable processor, programmable digital logic (e.g., field programmable gate array) or an application specific integrated circuit (ASIC) that comprises fixed digital logic, or a combination thereof. For example, the processor 120 may be embodied by digital logic gates in a fixed or programmable digital logic integrated circuit, which digital logic gates are configured to perform the process logic 200.

The data storage unit 150 is a larger memory storage that may store the data for the lists that are presented to the user as well as additional information for an item in the list and the digital media content associated with items in the lists of items that a user may navigate. Data is also stored in the data storage unit for other lists that may be presented to a user (such as other list categories) and through which a user may jump to an item that contains a string entered by the user as described herein. Thus, the digital media content for one or more of the items in the displayed list of items 20 may reside locally at the controlled device 10. In some cases, the data for the various lists of items that may be presented to a user may be stored in the memory 140 rather than in the data storage unit 150.

On the other hand, the digital media content for one or more of the items in the displayed list of items may reside remotely from the controlled device. To this end, the communication transceiver 160 may be a wired or wireless communication transceiver that is configured to receive a wired or over-the-air (OTA) transmission (from the Internet, a satellite or ground-based transmitter) containing digital content associated with one or more of the items in the displayed list of items. Thus, the controlled device may be a cable set-top box, a satellite television set-top box, or a PC. When a user selects an item from the displayed list of items, a command is sent via the communication transceiver to a head-end or other suitable equipment to cause the transmission of the underlying data for digital media content corresponding to a selected item to the controlled device 100 where it may be presented to a user. In another form, the data for the digital media content is retrieved from an Internet-based remote source and to this end the communication transceiver is simply a modem, or network interface (e.g., Ethernet card) that is used to connect to a web site or other Internet source of content.

Moreover, the communication transceiver 160 may be employed to receive digital media content that is then locally stored for local retrieval upon selection by a user using the DAN techniques described herein. Thus, the communication transceiver 160 is not required for purposes of performing the DAN techniques described herein, but it may be used as a way to retrieve digital media content based on a selection (either on-demand) or for local storage from which it is later retrieved in response to a user selection.

While the foregoing description of FIG. 4 refers the use of IR wireless transmission techniques between the remote control device 10 and the controlled device 100, this is only by way of example. There are other types of wireless communication techniques, such as radio frequency (RF), by which a remote control device may send wireless commands to the controlled device. Furthermore, the link between the remote control device 10 and the controlled device 100 may be a wired link.

FIG. 5 illustrates another example of an environment in which the DAN techniques may be employed. In the example of FIG. 5, the alphanumeric keypad and the display that displays the list of items are the same device shown at reference numeral 300. Thus, FIG. 5 shows an electronic device 300 that comprises an alphanumeric keypad 305, a processor 310, a display 320, a memory 330, a data storage unit 340 and an optional transceiver 350. The memory 330 stores instructions for the DAN process logic 200 that, when executed by the processor 310, cause the processor to perform the DAN techniques described herein. The data storage unit 340 may locally store digital data for one or more of the digital media content that can be selected by a user using the DAN techniques described herein. The transceiver 350 may also be provided to retrieve from a remote source, digital data for one or more of the digital media content that can be selected by a user. Data for the various lists of items that are presented to a user may be stored in the memory 330 or the data storage unit 340.

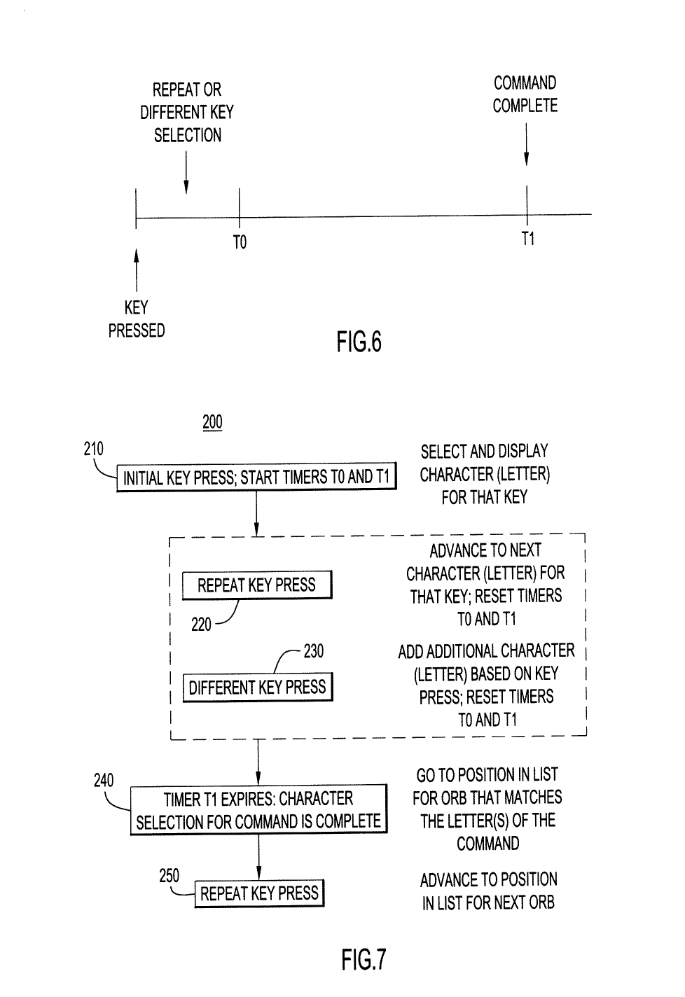

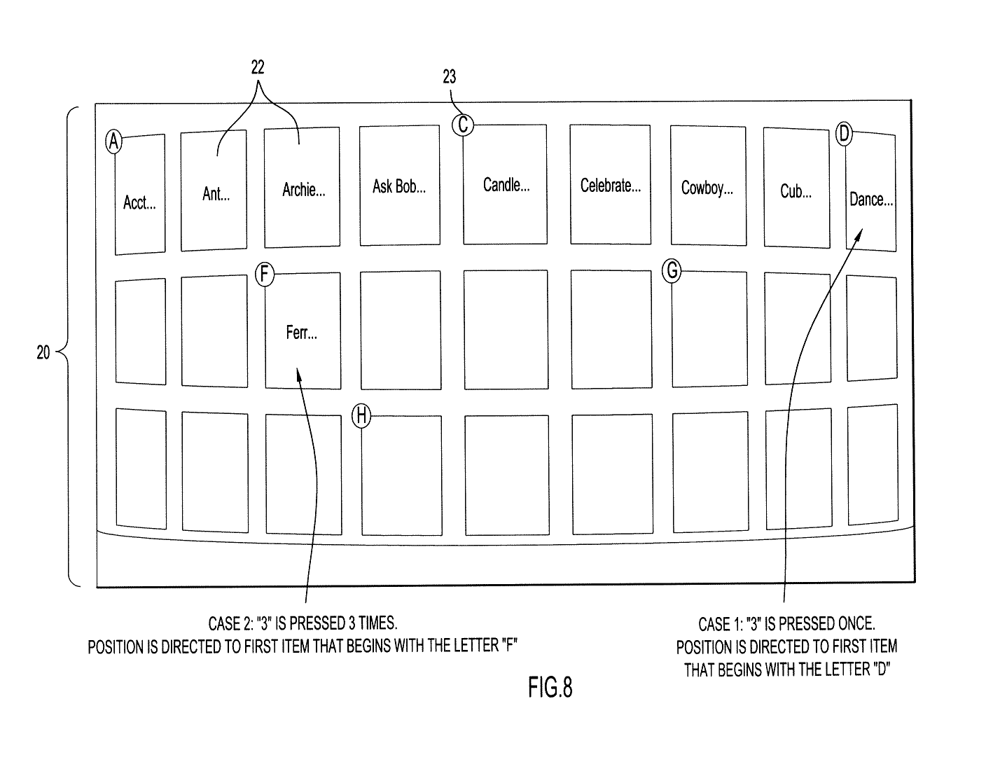

Reference is now made to the FIGS. 6 and 7 for a description of the operation of the DAN process logic 200. The process logic 200 is configured to generate a string of one or more characters (e.g., alphabetical letters or other characters such as “@” and space bar) from numeric key selection(s) to directly navigate to an element in the list that has a name or title that begins with or contains the string of one or more characters. As depicted in FIG. 6, there are two timers T0 and T1 that are used to control transitions between states depending upon the occurrence or no occurrence of a key selection. Timer T0 is referred to as a key press repeat timer and has a duration of first predetermined time period and timer T1 is referred to as a command complete timer and has a duration of a second predetermined time period. The relative length of the time associated with the key press repeat timer T0 and the command complete timer T1 are shown in FIG. 6. The key press repeat timer T0 is set to be a relatively short period of time and the command complete timer T1 is set to be several orders of magnitude longer than the repeat timer. In one example, the key press repeat timer T0 is 100 ms and the command complete timer T1 is 750 ms. The key press repeat timer T0 is the time interval during which a press of the same key selects the next successive letter associated with the key. If the same key is pressed more times than the number of letters associated with the key, the sequence wraps around to the first letter for that key and continues in sequence. The command complete timer T1 is the time interval during which presses of different keys will be accepted as appending to the current string sequence to construct a multi-letter direct navigation string. Both timers start running in response to any one of the alphanumeric keys “0”-“9” being pressed. Transitions between states depend on whether or not a key is pressed (the same key or a different key) before expiration of the repeat timer T0 and after the expiration of the command complete timer T1.

At function 210, an initial key press is detected. This is the first time any key (“0”-“9”) is pressed. A character or letter counter i is used to track key presses of the same key to determine whether to change to the next character for that key. The initial state of the character counter i is “0”. Upon detecting a initial key press at 210, the first letter, Char[i], i=0, is obtained and displayed for the key that was pressed. For example, pressing the key “2” twice (within the time window of the repeat timer T0) will go from the letter A (i=0) to the letter B (i=1). Thus, upon a key press, the letter or character Char[i], where i=0 is selected and the repeat timer T0 and the command complete timer T1 are started.

After function 210 detects an initial key press, the timers T0 and T1 begin running. Until the timer T0 expires, the following events are possible as detected by functions 220 and 230. At 220, a key press of the same key (as pressed at 210) is detected. When this occurs, the character counter i is incremented to obtain the next letter for that key. Also, upon a repeat key press, the repeat timer T0 and the command timer T1 are restarted. The function 220 may be performed repeatedly if the same key is pressed repeatedly, each time before the repeat timer T0 expires. The character counter i is reset after a predetermined number of presses and returns to the first letter for that key due to the maximum number of letters or characters associated with a given key. In other words, the character counter is incremented modulo the number of letters associated with the particular key. For example, there are 3 letters associated with keys “2”-“6” and “8” and 4 letters associated with keys “7” and “9”. Therefore, the character counter i is reset to zero after the third repeated key press of keys “2”-“6” and “8” and after the fourth repeated key presses of keys “7” and “9”.

When the repeat key timer T0 expires, then a press of the same key will begin the letter selection process for the next letter in the string. However, it is still possible that a second different key may be pressed before or after expiration of the timer T0 but before expiration of the command complete timer T1. Thus at function 230, it is detected when a user presses a different (second) key after the first key press, before or after expiration of the repeat key timer T0 but before expiration of the command complete timer T1. When this occurs, a second character (letter) is obtained corresponding to the first press of that key, and the letter selection process begins again for the second letter. It is possible that a user may advance to a different character for that second key by pressing that second key again. This would invoke the repeat key press function 220 again to advance to the next character for that second key. Also, the repeat timer T0 and command complete timer T1 is reset upon a different key being pressed. A user may append additional characters to one or more characters already entered for a string or insert regular expression characters (such as “*” and “.”) by pressing additional different numeric keys before or after expiration of the repeat key timer T0 but before expiration of the command complete timer, to generate a string of multiple characters of any length.

Once the command complete timer T1 expires, then at function 240, character selection is complete. (This may involve a single character or multiple characters.) The user is directed to the position for the particular item in the display of the list of items that corresponds to the letter or letters of the command whether or not an orb was associated with the particular item. In other words, the direct navigation is made to a particular item based on the string of one or more characters generated (from one or more numeric key presses) as of the expiration of the command complete timer T0 from the most recent numeric key press. In addition, when a user repeats the key press of the same key that was last pressed before expiration of the timer T1, then at function 250, the position in the list of items is advanced to the next orb.

The following example cases are provided to further explain the operation of the DAN process logic 200. In each of these examples, the status of the repeat timer T0 and command complete timer T1 is given. In addition, in each of the following case examples, when the user is navigated to a position in the list (based on the text string that the user inputs), the position may be indicated by any of the aforementioned position indicators (highlighting, flashing cursor, enlarging of the item, or other means, etc.) and any other position indicators now known or hereinafter developed. In addition, in the following case examples, orbs are shown as being displayed and the item to which a navigation is made also is the first item in a group of items; therefore it has an orb associated with it. However, this is only an example. The direct navigation is made to the item that has a name or title that has a letter or letters that begins with or contains (when using regular expression characters) the string entered by the user via numeric key selection. In all of these case examples except Case 5, the orbs could be deleted because they are not involved in the direct navigation process.

Case 1: Single Key Press—Primary Letter Selected.

In this case, a user presses one of the keys “0”-“9” once in order to select a primary letter. The following example is given where the key “3” is pressed.

Case 1: Single Key Press - Primary Letter Selected

| | | | | Command |
|---|---|---|---|---|
| | | | Repeat | Complete |
| | | Selected | Timer | Timer |
| | Event Description | Letter | T0 | T1 |
| 1 | User presses “3” key. | D | Start | Start |
| 2 | T0 (Repeat Timer) timeout | D | Stop | Running |
| 3 | T1 (Command Complete Timer) | D | Stop | Stop |
| | timeout | | | |

The position in the list of items is then directed to the first item that begins with the letter “D” and possibly marked with an orb (if the system has been configured to display orbs). This is shown in FIG. 8. The first graphical element next to the orb for the letter D is highlighted or otherwise made prominent. Once the command completes the item corresponding to the “D” is highlighted to show the user's current position in the list. In addition, the user may thereafter use standard navigation buttons (e.g., left, right, up, down) to move through the displayed list, and in doing so, the graphical element 22 for the current position may be enlarged or highlighted to visually indicate the current position to the user.

Case 2: Repeat Press—Single Secondary Letter Selection

In this example case, a user presses the same key three times before the expiration of the T0 timer to advance to the next character for that key. For this example, the key that is pressed is the “3” key, to advance from the letter “D” to “E” and ultimately to “F”. The position in the list of items is then directed to the first item that begins with the letter “F”, and in this example there is also an orb associated with the first item whose name or title begins with the letter F. This is shown in FIG. 8.

Case 2: Repeat Key Press - Single Secondary Letter Selection

| | | | | Command |
|---|---|---|---|---|
| | | | Repeat | Complete |
| | | Selected | Timer | Timer |
| | Event Description | Letter | T0 | T1 |
| 1 | User presses “3” key: 1st press. | D | Start | Start |
| 2 | User presses “3” key: 2nd press. | E | Restart | Restart |
| 3 | User presses “3” key: 3rd press. | F | Restart | Restart |
| 4 | T0 (Repeat Key) timeout | F | Stop | Running |
| 5 | T1 (Command Complete) timeout | F | Stop | Stop |

Case 3: Two Different Keys Pressed—Two Letter Selection

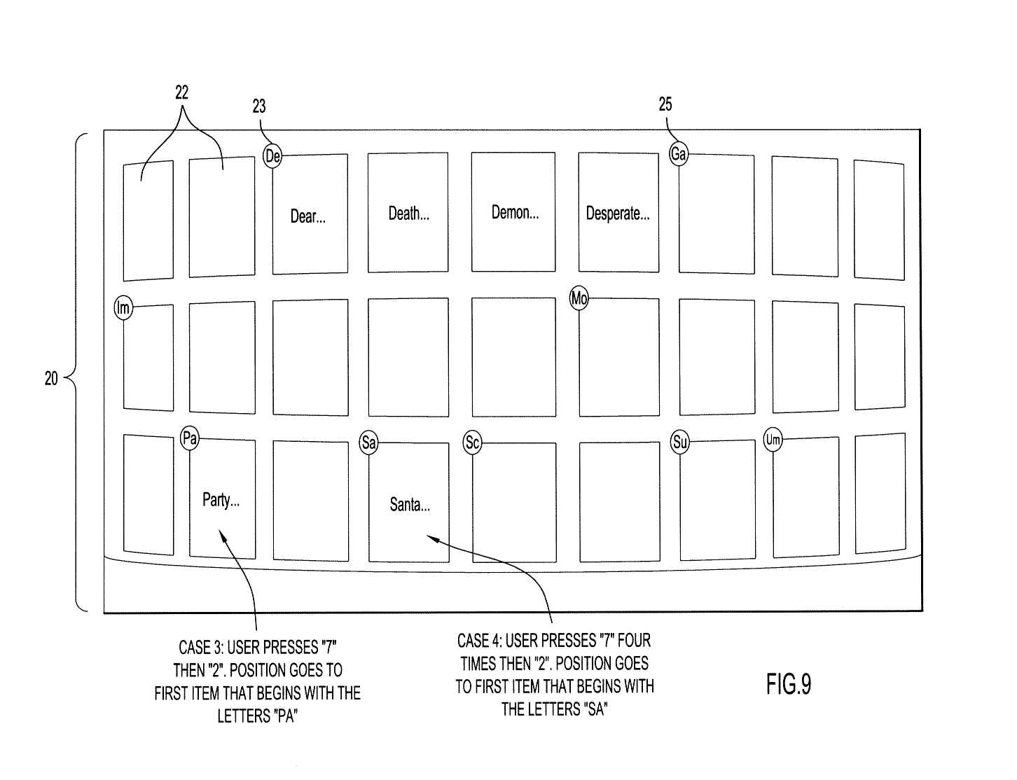

In this example, a user presses the “7” key once to select the letter “P” and then presses the “2” key once before or after the expiration of the T0 timer to select the letter “A”. Thus, the two letter string for this example is “PA”. The position in the list of items is then directed to the first item whose name or title begins with the letters “PA”. This is shown in FIG. 9, and there is also an orb displayed in this example.

Case 3: Two Different Keys Pressed - Two Letter Selection

| | | | | Command |
|---|---|---|---|---|
| | | | Repeat | Complete |
| | | Selected | Timer | Timer |
| | Event Description | Letter | T0 | T1 |
| 1 | User presses “7” key: 1st press. | P | Start | Start |
| 2 | User presses “2” key: 2nd press. | PA | Restart | Restart |
| 3 | T0 (Repeat Key) timeout | PA | Stop | Running |
| 4 | T1 (Command Complete) timeout | PA | Stop | Stop |

Case 4: Repeat Key Press & Different Keys Pressed—Two Letter Selection

In this example, a user presses the same key multiple times to advance through several letters associated with the key pressed to make the first letter selection, and then selects a second letter. For this example, the “7” key is pressed four times to advance to the letter “S” associated with that key, and then the “2” key is pressed to select the letter “A”. Thus, the two letter selection for this example is “SA”. The position in the list of items is then directed to the first item whose name or title begins with the letters “SA”. This is shown in FIG. 9, and again there is also an orb displayed as an example.

Case 4: Repeat Key Press & Different Keys Pressed -
Two Letter Selection

| | | | | Command |
|---|---|---|---|---|
| | | | Repeat | Complete |
| | | Selected | Timer | Timer |
| | Event Description | Letter | T0 | T1 |
| 1 | User presses “7” key: 1st press. | P | Start | Start |
| 2 | User presses “7” key: 2nd press. | Q | Restart | Restart |
| 3 | User presses “7” key: 3rd press. | R | Restart | Restart |
| 4 | User presses “7” key: 4th press. | S | Restart | Restart |
| 5 | User presses “2” key: 5th press. | SA | Restart | Restart |
| 6 | T0 (Repeat Key) timeout | SA | Stop | Running |
| 7 | T1 (Command Complete) timeout | SA | Stop | Stop |

Case 5: Advance to Next Orb with Repeat Key Press

In this example, the user presses the “3” key once and both the repeat key press timer T0 and the command complete timer T1 expire. The position in the list of items is then directed to the first item whose name or title begins with the letter “D”. Then, the user presses the “3” key again and both the repeat key press timer T0 and the command complete timer T1 expire. This causes the position in the list of items to be directed to the next orb, which is, for example, the orb for “De”. This example case is shown in FIG. 10.

Case 5: Advance to Next Orb with Repeat Key Press

| | | Selected | Repeat | Complete |
|---|---|---|---|---|
| | Event Description | Letter | T0 | T1 |
| 1 | User presses “3” key: 1st press. | D | Start | Start |
| 2 | T0 (Repeat Key) timeout | D | Stop | Running |
| 3 | T1 (Command Complete) timeout | D | Stop | Stop |
| 4 | User presses “3” key: 2nd press. | De | Start | Start |
| 5 | T0 (Repeat Key) timeout | De | Stop | Running |
| 6 | T1 (Command Complete) timeout | De | Stop | Stop |

Case 6: Implicit Search Restart

In this example, the user presses the “4” key twice before the expiration of the T0 timer to select the letter “H” then both the repeat key press timer T0 and the command complete timer T1 expire. The DAN process submits the search string “H” and the position (e.g., cursor) is directed to the first item whose name or title starts with “H”. However, the user immediately changes his/her mind to be positioned to a different item and presses the “3” key once to select the letter “D”. Both the repeat key press timer T0 and the command complete timer T1 expire causing the system to issue the position command to the first item that begins with the letter “D” and the user interface updates the highlighted item accordingly to indicate this new position. This example illustrates the DAN process's ability to dynamically adjust the highlighted cursor position as the user presses alphanumeric keys without the user having to explicitly issue a separate command between the two string entries for position requests. This example case is shown in FIG. 2.

Case 6: Implicit Search Restart

| | | Selected | Repeat | Complete |
|---|---|---|---|---|
| | Event Description | Letter | T0 | T1 |
| 1 | User presses “4” key: 1st press. | G | Start | Start |
| 2 | User presses “4” key: 2nd press. | H | Restart | Restart |
| 3 | T0 (Repeat Key) timeout | H | Stop | Running |
| 4 | T1 (Command Complete) timeout | H | Stop | Stop |
| 5 | User presses “3” key: 1st press. | D | Start | Start |
| 6 | T0 (Repeat Key) timeout | D | Stop | Running |
| 7 | T1 (Command Complete) timeout | D | Stop | Stop |

Case 7: Jump to Items Containing a String

In this example, a regular expression is used to jump to items that contain a character string in their title or name. For example, the regular expression “*FAT” is entered, which allows a user to jump to items that contain the word “FAT” in the title. In this example, the “*” character is entered by pressing the “1” key twice.

Case 7: Jump to Items Containing a String

| | | Selected | | |
|---|---|---|---|---|
| | | Letter/ | Repeat | Complete |
| | Event Description | Character | T0 | T1 |
| 1 | User presses “1” key: 1st press. | @ | Start | Start |
| 2 | User presses “1” key: 2nd press. | * | Restart | Restart |
| 3 | T0 (Repeat Key) timeout | * | Stop | Running |
| 4 | User presses “3” key: 1st press | *D | Restart | Restart |
| 5 | User presses “3” key: 2nd press. | *E | Restart | Restart |
| 6 | User presses “3” key: 3rd press. | *F | Restart | Restart |
| 7 | T0 (Repeat Key) timeout | *F | Stop | Running |
| 8 | User presses “2” key: 1st press. | *FA | Restart | Restart |
| 9 | T0 (Repeat Key) timeout | *FA | Stop | Running |
| 10 | User presses “8” key: 1st press. | *FAT | Restart | Restart |
| 11 | T0 (Repeat Key) timeout | *FAT | Stop | Running |
| 12 | T1 (Command Complete) timeout | *FAT | Stop | Stop |

After “*FAT” is entered, the user is directed to the first item in the current list category that is being presented to the user that has a name or title that contains the expression “FAT”. The user can thereafter jump to the next item that contains “FAT” by pressing the forward key (right pointing arrow, shown in FIG. 1). The next item that contains “FAT” may be in the current list category or in another list category if there are no other items that contain the expression “FAT”. For example, a first (the current) list category may be “Recent Releases” of movie titles. After the user has jumped through all items in the “Recent Releases” list category, the user can continue to navigate to items in other list categories (second, third, etc., list categories), such as “New Releases” and then to other categories such as “Classics”, and even to other list types of lists such as lists of music, games, etc., to navigate to items in those lists that contain the expression “FAT”. By continuing to press the “FWD” key, the user is navigated to the next item (whether in the current list category or a next list category) that contains that expression. Similarly, the user may press the “BACK” (left pointing arrow) key to go back to the previous item containing that expression, again within a current list category or when no other items (going backwards) in the current list category contain that expression than to an item in a previous list category.

As explained above, list categories may be organized in a predetermined order, such as “New Releases”, then “Recent Releases”, then alphabetically by topic such as “Action”, “Comedy”, “Drama”, and so on. Thus, jumping to an item in the “next” list category may involve going to an item in the next list category according to the predetermined order of list categories, depending on which list category is currently being presented to the user.

Turning now to FIG. 11, a flow chart is shown that depicts how the DAN process 200 is part of an overall user interface process 400. At 410, a plurality of graphical or text elements are displayed on a display device, where the graphical or text elements are arranged in a predetermined order. The graphical or text elements may represent digital content (movies, games, songs, other types of video programs) to be presented, or they may represent other data, such as emails, contact names, etc. At 420, a signal is received representing selection (press) of one or more numeric keys among a plurality of numeric keys. Each numeric key comprises a visual notation of a number and one or more alphabetical characters. The signal representing selection of the numeric key may be generated on a remote control device and transmitted to a controlled device from the remote control device, as depicted in FIG. 4. The controlled device may be a display device on which the list of graphical or text elements are displayed, or the controlled device may be an intermediate device that is connected to the display device, where the direct navigating functions of the DAN process 200 are performed on the intermediate device, as depicted in FIG. 4.

As depicted in FIG. 11, the DAN process 200 is invoked to translate the numeric key selection made at 420 to a corresponding position in the predetermined order of the plurality of graphical or text elements. This involves generating a string of one or more characters from the numeric key selection(s) made by a user, and then directly navigating to an element in the list that has a name or title that begins with the string of one or more characters. This may involve moving a cursor or other user interface focus element to a particular element in the list. In so doing, the array of elements that are displayed may shift from a first subset of graphical elements currently on the display screen to a second subset of graphical elements on the display screen that contains (at the begin, a center position, or some other position in the display screen) the element that has a name or title that contains or begins with the string of one or more characters. In one form, navigation is made to the item that has a name or title that begins with the string. In another form, navigation is made to an item that has a name or title that contains that string (not necessarily beginning with that string). For example, a user may know a particular term that may be contained in a name or title of an item in the list, but does not know the entire name or title to know the first word in title. Therefore, the DAN navigation techniques may be used to directly navigate to the first item in the list that contains a string of characters. The user may then traverse other matches for the same string by using the “FWD” and “BACK” keys.

As explained herein, the predetermined order in which the plurality of graphical or text elements are arranged is an alphabetical order by a word or phrase associated with each of the elements (name, title, etc.). The direct navigating function performed by the DAN process 200 involves translating the selection to an alphabetical position (that is, to a particular item) in the plurality of graphical or text elements that corresponds to (i.e., has a name or title that contains or begins with) a string of one or more alphabetical characters generated from one or more the selected numeric keys. Moreover, navigational markers (i.e., the “orbs” referred to herein) may be displayed within the plurality of graphical elements corresponding to alphabetical characters to visually delineate to a user groups of graphical or text elements. The translation made by the DAN process involves translating selection of one or more numeric keys to a particular item in the list that may or may not be marked with navigational markers, based on the string of one or more letters generated from selection of one or more numeric keys. A repeat selection of the same numeric key (after a predetermined period of time has expired) may result in an advance to a position in the list of displayed items to the next navigational marker. The details of the operation of the DAN process 200 are described above.

In summary, the techniques described herein allow for a user to directly navigate to a particular item in a list of items arranged in a predetermined order, based on key presses of a basic numeric keypad, where each key has one or more letters assigned to it. These techniques facilitate selection of an item within a long list of items without the use of incremental navigation or direct search functions. To reiterate, the DAN techniques described herein direct a user interface focus element (e.g., a cursor or pointer) to a particular item in a displayed list of items without executing a search function. Whereas a search function involves entering a search query and returning all results that match that search, the DAN techniques involve directly navigating to a particular item in a list based on a string of one or more characters generated from user selection (button press) of one or more numeric keys while operating in context of the original user interface display. A user may jump from one item to another item by entering a new string and without executing any other search command or similar function.

The DAN techniques permit navigation to a particular item within a list. The data for the list can be and is most likely resident within the local device (i.e. set-top box, PC or other device). The navigation to the particular item is not necessarily directly related to the function that will occur if the user “selects” the item to which the navigation is made. In one example, selection of the item could result in providing more detailed information regarding the item from the local device or a remote source. Alternatively, selection of the item could result in immediate playback of the item, which “playback” is determined based on type of item that was selected, i.e. video, audio, or an application software.

The above description is intended by way of example only.

What is claimed is:

1. A method comprising:
displaying on a display device a plurality of graphical or text elements arranged in a predetermined order;
receiving a signal representing selection of one or more numeric keys among a plurality of numeric keys; and
generating data representing a string of one or more characters from the signal representing selection of one or more numeric keys;
directly navigating to a particular element in the plurality of graphical or text elements based on the string of one or more characters.

2. The method of claim 1, wherein displaying comprises displaying the plurality of graphical or text elements arranged in alphabetical order by a word or phase associated with each of the graphical or text elements, and wherein directly navigating comprises moving a cursor position to one of the plurality of graphical or text elements that contains or begins with the string of one or more characters.

3. The method of claim 2, wherein receiving the signal comprises receiving the signal representing selection of one or more numeric keys on a numeric key pad comprising a plurality of keys each comprising a visual notation of a number and one or more alphabetical or other characters.

4. The method of claim 3, wherein generating the string comprises advancing to a different character of a plurality of characters assigned to a numeric key in response to repeat selection of the same numeric key within a first predetermined time period.

5. The method of claim 4, wherein generating the string comprises appending a different character to one or more characters already entered for a string in response to selection of a different numeric key than previously selected before or after expiration of the first predetermined time period.

6. The method of claim 5, wherein directly navigating is based on the string of one or more characters generated as of expiration of a second predetermined time period from a most recent selection of a numeric key, wherein the second predetermined time period is longer than the first predetermined time period.

7. The method of claim 6, wherein displaying comprises displaying navigational markers corresponding to alphabetical characters within the plurality of graphical or text elements, and wherein directly navigating comprises navigating to graphical or text element associated with a next navigational marker in the plurality of graphical or text elements in response to selection of the same numeric key after expiration of the second predetermined time period.

8. The method of claim 7, and further comprising generating data for positioning the navigational markers in the plurality of graphical or text elements based on predefined or user configurable parameters as to a maximum number of graphical or text elements to be displayed between consecutive navigational markers.

9. The method of claim 6, wherein directly navigating comprises directly navigating to an element that begins with or contains a first string and subsequently directly navigating to an element that begins with or contains a second string without a separate command between the entries for the first and second strings.

10. The method of claim 1, wherein receiving comprises receiving the signal transmitted by a remote control device.

11. The method of claim 1, wherein receiving comprises receiving the signal at the display device.

12. The method of claim 11, wherein receiving comprises receiving the signal at an intermediate device that is connected to the display device, and wherein said generating and directly navigating is performed on said intermediate device.

13. The method of claim 1, wherein the plurality of graphical or text elements represent digital media content comprising one or more of video programs, software applications, music, and game software.

14. The method of claim 13, and further comprising retrieving data for digital media content in response to user selection of a corresponding graphical or text element.

15. The method of claim 13, and further comprising retrieving information related to digital media content in response to user selection of a corresponding graphical or text element.

16. The method of claim 1, wherein directly navigating comprises directly navigating to an element in a first list category and thereafter directly navigating to other elements in the first list category that begin with or contain the string in response to a navigation command, and when no other elements in the first list begin with or contain the string, directly navigating to an element that begins with or contains the string in a second list category.

17. An apparatus comprising:
a remote control device having a plurality of alphanumeric keys and configured to transmit a signal representing selection of one or more of the alphanumeric keys, each key comprising a visual notation of a number and one or more alphabetical or other characters;
a controlled device configured to receive the signal transmitted by the remote control device, wherein the controlled device comprise a processor configured to:
generate display data for supply to a display device to display a plurality of graphical or text elements arranged in a predetermined order;
generate data representing a string of one or more characters from the signal received from the remote control device; and
generate data to directly navigate to a particular element in the plurality of graphical or text elements based on the string of one or more characters.

18. The apparatus of claim 17, wherein the processor is configured to generate display data for the plurality of graphical or text elements that represent digital media content.

19. The apparatus of claim 18, wherein the processor is further configured to retrieve data for digital media content in response to a signal from the remote control device that represents user selection of a corresponding graphical or text element.

20. The apparatus of claim 18, wherein the processor is further configured to retrieve and present information related to digital media content in response to a signal from the remote control device that represents user selection of a corresponding graphical or text element.

21. The apparatus of claim 17, wherein the processor is configured to generate data to display the plurality of graphical or text elements arranged in alphabetical order by a word or phrase associated with each of the graphical or text elements, and to generate data to move a cursor position to one of the plurality of graphical or text elements that contains or begins with the string of one or more characters.

22. The apparatus of claim 21, wherein the processor is configured to generate data for the string of characters to select a different character of a plurality of characters assigned to an alphanumeric key in response to a signal received from the remote control device indicating repeat selection of the same alphanumeric key within a first predetermined time period, to append a different character to one or more characters already entered for a string in response to a signal received from the remote control device indicating selection of a different alphanumeric key than previously selected before or after expiration of the first predetermined time period, and wherein the processor is configured to generate data to directly navigate based on the string of one or more characters generated as of expiration of a second predetermined time period from a most recent selection of an alphanumeric key, wherein the second predetermined time period is longer than the first predetermined time period.

23. The apparatus of claim 21, wherein the processor is configured to generate data for displaying on the display device navigational markers corresponding to alphabetic characters within the plurality of graphical or text elements, and to generate data to navigate to a graphical or text element associated with a next navigational marker in the plurality of graphical or text elements in response to a signal received from the remote control device indicating selection of the same alphanumeric key after expiration of the second predetermined time period.

24. The apparatus of claim 23, wherein the processor is configured to generate data for positioning the navigational markers in the plurality of graphical or text elements based on predefined or user configurable parameters as to a maximum number of graphical or text elements to be displayed between consecutive navigational markers.

25. A processor readable medium storing instructions that, when executed by a processor, cause the processor to:
generate display data for supply to a display device to display a plurality of graphical or text elements arranged in a predetermined order, wherein the plurality of graphical or text elements represent digital media content;
generate data representing a string of one or more characters from a signal received from remote control device, the signal representing selection of one or more alphanumeric keys; and
generate data to directly navigate to a particular element in the plurality of graphical or text elements based on the string of one or more characters.

26. The processor readable medium of claim 25, and further comprising instructions that, when executed, cause the processor to retrieve data for digital media content in response to a signal from the remote control device that represents user selection of a corresponding graphical or text element.

27. The processor readable medium of claim 25, wherein the instructions that cause the processor to generate display data to display the plurality of graphical elements comprise instructions that cause the processor to generate display data to display the plurality of graphical or text elements arranged in alphabetical order by a word or phrase associated with each of the graphical or text elements, and to generate data to move a cursor position to one of the plurality of graphical or text elements that contains or begins with the string of one or more characters.

28. The processor readable medium of claim 27, and further comprising instructions that cause the processor to generate data to display navigational markers corresponding to alphabetic characters within the plurality of graphical or text elements, and to generate data to navigate to a graphical or text element associated with a next navigational marker in the plurality of graphical or text elements in response to a signal received from the remote control device indicating selection of the same alphanumeric key after expiration of a predetermined time period.

29. The processor readable medium of claim 28, and further comprising instructions that cause the processor to generate data for positioning the navigational markers in the plurality of graphical or text elements based on predefined or user configurable parameters as to a maximum number of graphical or text elements to be displayed between consecutive navigational markers.
